(19) United States
(12) Patent Application Publication
(10) Pub. No.: US 2013/0159514 A1
(43) Pub. Date: Jun. 20, 2013

(54) INFORMATION PROCESSING APPARATUS AND REMOTE MAINTENANCE METHOD

(71) Applicant: FUJITSU LIMITED, Kawasaki-shi (JP)

(72) Inventor: Kenji TAGASHIRA, Kawasaki (JP)

(73) Assignee: FUJITSU LIMITED, Kawasaki-shi (JP)

(21) Appl. No.: 13/764,326

(22) Filed: Feb. 11, 2013

Related U.S. Application Data
(63) Continuation of application No. PCT/JP2010/063827, filed on Aug. 16, 2010.

(51) Int. Cl. H04L 12/26

(52) U.S. Cl. CPC H04L 43/04
USPC 709/224

(57) ABSTRACT

An information processing apparatus may include a first sending unit to send, to a remote maintenance center, virtual domain configuration information indicating configurations of a plurality of virtual domains formed within the information processing apparatus, together with a virtual domain configuration event, and a second sending unit to send, to the remote maintenance center, information of a periodic connection event including a next periodic connection time of each of the plurality of virtual domains, together with a periodic connection event.

### CROSS-REFERENCE TO RELATED APPLICATIONS

This application is a continuation application of International Application No. PCT/JP2010/063827 filed on Aug. 16, 2010 and designated the U.S., the entire contents of which are incorporated herein by reference.

### FIELD

The embodiments discussed herein are related to an information processing apparatus, a remote maintenance method, and a computer-readable storage medium. The computer-readable storage medium may have stored therein a program for causing a computer to execute a process to make an abnormality notification suited for remote maintenance.

### BACKGROUND

Conventionally, a remote maintenance service may be provided in which an abnormality generated in an information processing apparatus, such as a computer, is notified to a manager. The abnormality in hardware or software of the information processing apparatus may be detected by a program installed in the information processing apparatus, and may be notified to a remote maintenance center via a network, for example. Such a remote maintenance center may be managed by a vendor who provides the remote maintenance service, in order to manage information related to the information processing apparatus sold by the vendor, monitor an abnormality notification from the information processing apparatus, and the like.

In order to provide an appropriate remote maintenance service, it may be preferable to positively notify the abnormality of the information processing apparatus to the remote maintenance center. Hence, in order to maintain a state in which the abnormality notification is possible, the information processing apparatus may be provided with a function of periodically making a notification to the remote maintenance center. In the following description, such a periodical notification to the remote maintenance center may also be referred to as a “periodic connection event”.

The remote maintenance center may monitor the periodic connection event, in order to monitor whether the information processing apparatus is in a state in which the remote maintenance is possible. The information processing apparatus may store, as periodic connection event data, a date and time or a time (hereinafter also referred to as “notification time information”) when the notification is to be made to the remote maintenance center at the next periodic connection event. The remote maintenance center may hold the data of the notification time information notified from the information processing apparatus, and monitor whether the periodic connection event is received from the information processing apparatus at the date and time or the time indicated by the notification time information. When the periodic connection event is not received from the information processing apparatus at the time and date or the time indicated by the notification time information held by the remote maintenance center, the remote maintenance center may judge that an abnormality of some kind is generated in the information processing apparatus and notify a manager of the information processing apparatus. Hence, the state in which the information processing apparatus notifies the abnormality may be maintained.

Conventionally, one OS (Operating System) runs in one information processing apparatus, and it may be sufficient for the remote maintenance center to monitor one periodic connection event with respect to one information processing apparatus. On the other hand, domains segmented in terms of hardware may exist within one information processing apparatus, and a plurality of OSs may run in the information processing apparatus proposed in recent years, as illustrated in FIG. 1.

FIG. 1 is a diagram illustrating an example of a network system that provides the remote maintenance service. In FIG. 1, a network system 1-1 may include a plurality of information processing apparatuses 2-1 through 2-N (where N is a natural number greater than or equal to 2), networks 3-1 through 3-N formed by the Internet or dedicated line, and a remote maintenance center 4. In this example, N is greater than or equal to 3. The information processing apparatus 2-1 may include a control domain 22 that includes a remote maintenance program 21. On the other hand, the information processing apparatus 2-2 may include domains 23-1 through 23-3 (#1 through #3), and a system monitoring mechanism 25 that includes a remote maintenance program 24. In addition, the information processing apparatus 2-N may include domains 26-1 through 26-3 (#1 through #3), and may be connected to another information processing apparatus 27 that is used for management purposes. The information processing apparatus 27 may include a remote maintenance program 28.

In the case of the network system 1-1 illustrated in FIG. 1, the system monitoring mechanism 25 that monitors the information processing apparatus 2-2 is provided within the information processing apparatus 2-2, and the information processing apparatus 27 is connected to the information processing apparatus 2-N, in order to notify an abnormality of the information processing apparatuses 2-2 and 2-N from the system monitoring mechanism 25 or the information processing apparatus 27 to the remote maintenance center 4. For example, the periodic connection event notified to the remote maintenance center 4 may include information (hereinafter also referred to as an “information processing apparatus ID”) for identifying the information processing apparatus uniquely assigned to each of the information processing apparatuses 2-1 through 2-N, a domain ID for identifying each domain, and notification time information. The remote maintenance center 4 may include an event receiving program 4A to receive the periodic connection events from the remote maintenance programs 21, 24 and 28 via the networks 3-1 through 3-N, and a storage part 4B to store the notification time information indicating the date and time or the time when the notification is to be made to the remote maintenance center 4 at the next periodic connection event, in a related manner to the information processing apparatus ID and the domain ID. The event receiving program 4A of the remote maintenance center 4 may manage the periodic connection event in units of the information processing apparatus IDs.

In addition, due to progress made in virtual machine technology, an information processing apparatus that does not have a system monitoring mechanism may run a plurality of OSs (hereinafter also referred to as a “virtual domain” or simply “domain”) within the single information processing apparatus by software as illustrated in FIG. 2, for example.

FIG. 2 is a diagram illustrating another example of the network system that provides the remote maintenance service. In FIG. 2, a network system 1-2 may include an information processing apparatus 31, a network 38 formed by the Internet or dedicated line, and a remote maintenance center 39. In this example, the information processing apparatus 31 may include a control domain (or a virtual domain) 33 that includes remote maintenance program 32, a plurality of guest domains (or virtual domains) 35-1 through 35-N that include remote maintenance programs 34-1 through 34-N (where N is a natural number greater than or equal to 2), respectively, a firmware layer 36, and interfaces 37-1 and 37-1 that may be formed by NICs (Network Interface Cards) or the like. In this example, the interface 37-1 has a virtual configuration and may be used by the control domain 33 and the guest domains 35-1 and 35-2. In addition, the interface 37-2 may be allocated exclusively for the guest domain 35-N, and may be used by the guest domain 35-N.

In the case of the network system 1-2 illustrated in FIG. 2, the periodic connection event from the plurality of domains 32 and 35-1 through 35-N to the remote maintenance center 39, that is, the abnormality notification, needs to be positively made in order to realize the remote maintenance service. The remote maintenance center 39 may include a receiving program 39A to receive the periodic connection event from the remote maintenance program 32 via the firmware layer 36, the interface 37-1 and the network 38, and a storage part 39B to store the notification time information indicating the date and time or the time when the notification is to be made to the remote maintenance center 39 at the next periodic connection event, in a related manner to the information processing apparatus ID and the domain ID.

In the network system 1-2, the period connection event notified from the information processing apparatus 31 to the remote maintenance center 39 may be limited to the periodic connection event from the remote maintenance program 32 of the control domain 33 that manages the guest domains 35-1 through 35-N (#1 through #N) for the reasons described hereinafter. For example, the periodic connection event notified to the remote maintenance center 39 may include the information processing apparatus ID of the information processing apparatus 31, and the domain ID for identifying each domain.

First, the event receiving program 39A of the remote maintenance center 39 manages the periodic connection events in units of the information processing apparatus IDs. For this reason, when the periodic connection event is notified from each of the guest domains 35-1 through 35-N, the receiving program 39A of the remote maintenance center 39 is unable to specify the guest domain from which the periodic connection event is received, because the periodic connection events are managed in units of the information processing IDs.

Second, because the guest domains 35-1 through 35-N are formed by software, the guest domains may frequently be increased or decreased within the network system 1-2. However, because the remote maintenance center 39 manages the periodic connection events in units of the information processing apparatus IDs, the remote maintenance center 39 is unable to follow the frequent increase or decrease in the guest domains. For this reason, it is impossible for the remote maintenance center 39 to judge whether the periodic connection event is not received due to the decrease in the guest domains, or the periodic connection event is not received due to an abnormality of some kind generated in the guest domain. Similarly, when the guest domains increase, it is impossible for the remote maintenance center 39 to judge whether the periodic connection event is received from one of the increased guest domains, or the periodic connection event is received from one of the existing guest domains.

Third, in addition to increasing or decreasing the guest domains, the user may stop a certain guest domain. However, because the remote maintenance center 39 manages the periodic connection event in units of the information processing apparatus IDs, it is impossible for the remote maintenance center 39 to judge whether an abnormality is generated in the certain guest domain, or the certain guest domain is stopped.

Accordingly, when the periodic connection event is limited to the periodic connection event from the remote maintenance program 32 of the control domain 33, it may be impossible to positively make the abnormality notification to the remote maintenance center 39 in a case in which the remote maintenance programs 34-1 through 34-N of each of the guest domains 35-1 through 35-N detect the abnormality. In other words, it may be impossible to positively provide a path between the remote maintenance programs 34-1 through 34-N of each of the guest domains 35-1 through 35-N and the interfaces 37-1 and 37-2. Hence, as may be seen from a flow of the periodic connection events indicated by bold solid line arrows in FIG. 2, the periodic connection events from the remote maintenance programs 34-1 through 34-N of the guest domains 35-1 through 35-N do not reach the network 38.

Examples of prior art systems may be found in Japanese Laid-Open Patent Publications No. 2003-173272, No. 9-251381, and No. 5-158721, for example.

According to the conventional remote maintenance method, it may be difficult to positively make the abnormality notification in the virtual domain environment within the information processing apparatus by the periodic connection event.

### SUMMARY

Accordingly, it is an object in one aspect of the embodiment to provide an information processing apparatus, a remote maintenance method, and a computer-readable storage medium, which may positively make the abnormality notification in the virtual domain environment within the information processing apparatus by the periodic connection event.

According to one aspect of the present invention, an information processing apparatus may include a first sending unit configured to send, to a remote maintenance center, virtual domain configuration information indicating configurations of a plurality of virtual domains formed within the information processing apparatus, together with a virtual domain configuration event; and a second sending unit configured to send, to the remote maintenance center, information of a periodic connection event including a next periodic connection time of each of the plurality of virtual domains, together with a periodic connection event.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network system that provides a remote maintenance service;

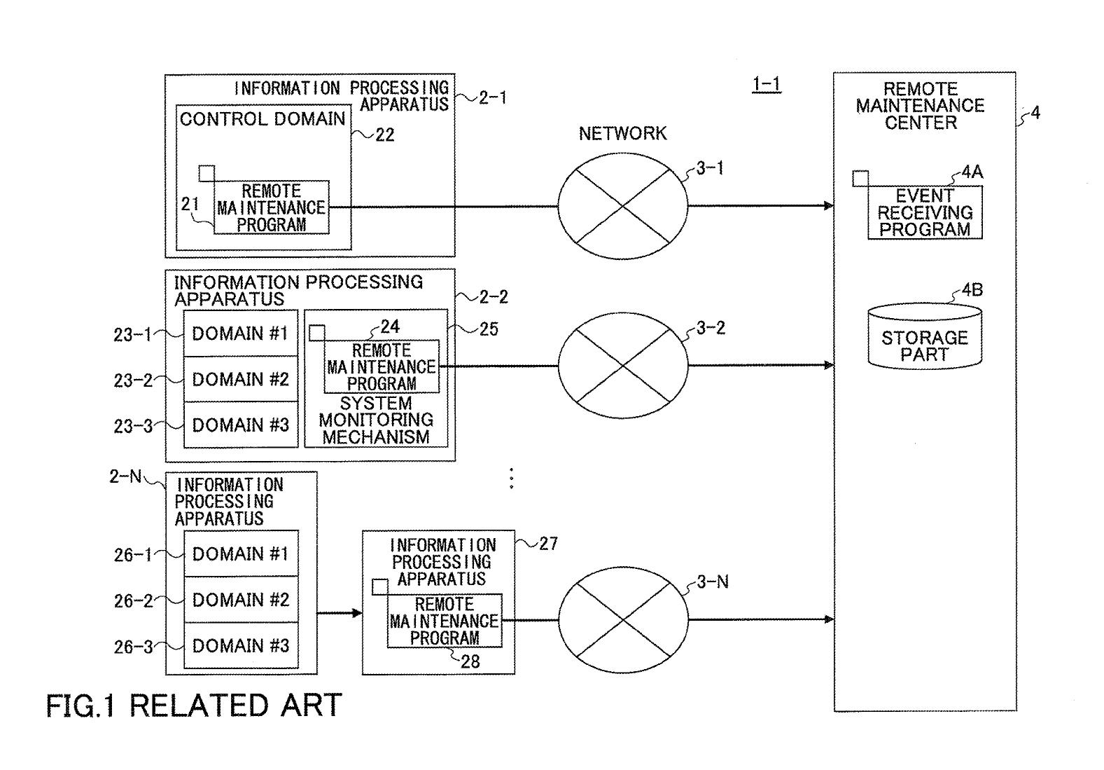

FIG. 2 is a diagram illustrating another example of the network system that provides the remote maintenance service;

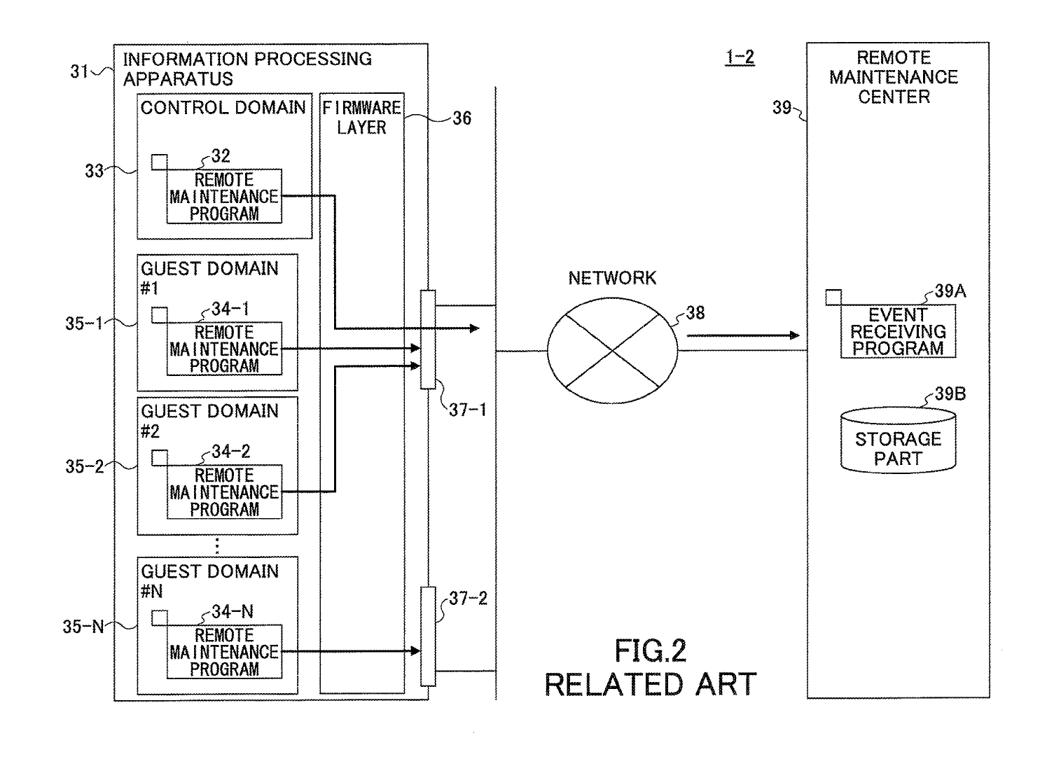

FIG. 3 is a diagram illustrating an example of a network system in a first embodiment;

FIG. 4 is a flow chart for explaining an example of a process of an information processing apparatus;

FIG. 5 is a diagram for explaining an example of notification time information stored in a storage part of a remote maintenance center;

FIG. 6 is a flow chart for explaining an example of a process to send a virtual domain configuration event;

FIG. 7 is a diagram for explaining an example of data notified by the process to send the virtual domain configuration event;

FIG. 8 is a flow chart for explaining an example of a process to send a periodic connection event;

FIG. 9 is a flow chart for explaining an example of a process of an event receiving program;

FIG. 10 is a diagram for explaining an example of a transition for a case in which data of guest domains stored in the remote maintenance center increases;

FIG. 11 is a diagram for explaining an example of a transition for a case in which the data of guest domains stored in the remote maintenance center decreases;

FIG. 12 is a flow chart for explaining another example of the process of the event receiving program;

FIG. 13 is a diagram illustrating an example of the network system in a second embodiment;

FIG. 14 is a flow chart for explaining an example of a process of the event receiving program;

FIG. 15 is a diagram illustrating an example of the network system in a third embodiment;

FIG. 16 is a flow chart for explaining an example of a process of a periodic connection management program; and

FIG. 17 is a block diagram illustrating an example of a computer system forming the information processing apparatus.

### DESCRIPTION OF EMBODIMENTS

Preferred embodiments of the present invention will be described with reference to the accompanying drawings.

A description will now be given of the information processing apparatus, the remote maintenance method, and the computer-readable storage medium in each embodiment according to the present invention.

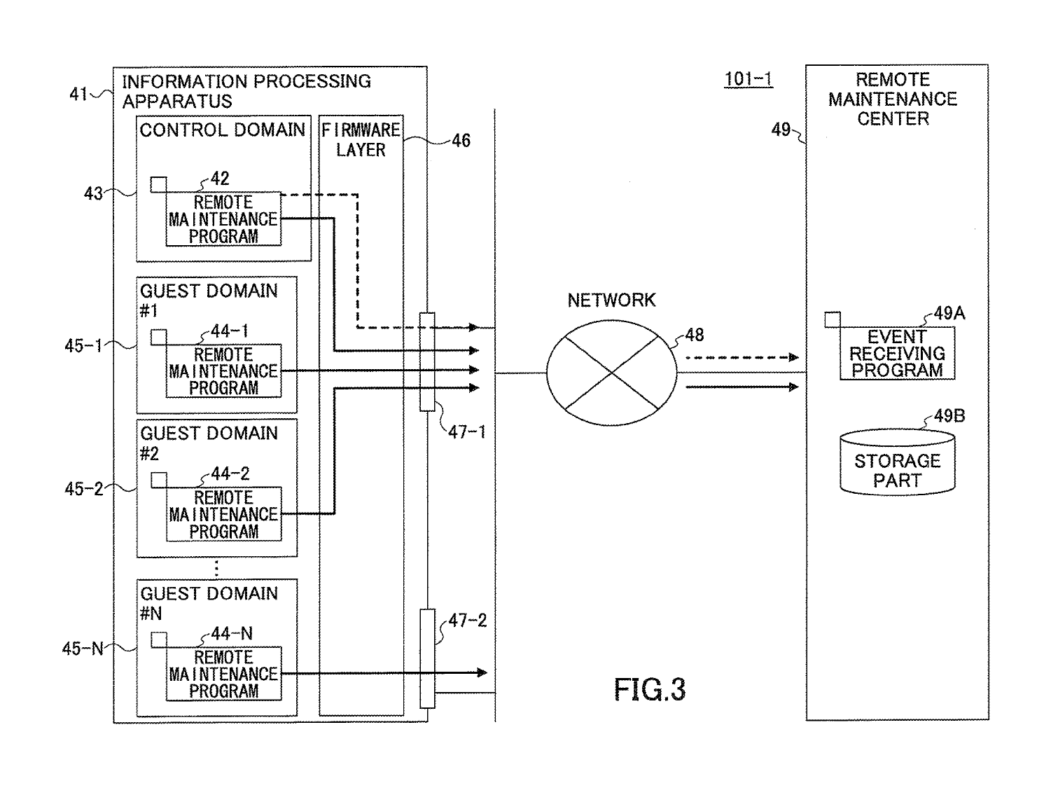

FIG. 3 is a diagram illustrating an example of a network system in a first embodiment. In FIG. 3, a network system 101-1 may include an information processing apparatus 41, a network 48 formed by the Internet or dedicated line, and a remote maintenance center 49. A plurality of virtual domains may be formed within the information processing apparatus 41 by known virtual configuration software. In this example, the information processing apparatus 41 may include a virtual domain (hereinafter also referred to as a “control domain”) 43 that manages all virtual domains within the information processing apparatus 41, and virtual domains (hereinafter also referred to as “guest domains”) 45-1 through 45-N (where N is a natural number greater than or equal to 2) other than the control domain 43. A remote maintenance program 42 to perform a remote maintenance may be executed in the control domain 43. Remote maintenance programs 44-1 through 44-N to perform a remote maintenance may be executed in the guest domains 45-1 through 45-N (#1 through #N), respectively. Each of the remote maintenance programs 42 and 44-1 through 44-N may execute a periodic connection event or a virtual domain configuration event to be described later.

The information processing apparatus 41 may include, in addition to the control domain 43 and the guest domains 45-1 through 45-N, a firmware layer 46, and interfaces 47-1 and 47-2 that may be formed by NICs (Network Interface Cards) or the like. In this example, the interface 47-1 has a virtual configuration, and may be used by the control domain 43 and the guest domains 45-1 and 45-2. In addition, the interface 47-2 may be allocated exclusively for the guest domain 45-N, and may be used by the guest domain 45-N.

The remote maintenance program 42 of the control domain 43 may include a virtual domain configuration event function. The virtual domain configuration event function may send a virtual domain configuration event to the remote maintenance center 49. The virtual domain configuration event may include information (hereinafter also referred to as “information processing apparatus ID”) for identifying the information processing apparatus 41, for example, and indicates the configuration (that is, virtual domain configuration information) of the virtual domains formed within the formation processing apparatus 41, and data such as a number N+1 of virtual domains (or number N of guest domains 45-1 through 45-N), domain IDs for identifying each of the domains 43 and 45-1 through 45-N, and the like. Hence, the remote maintenance center 49 that includes the event receiving program 49A and the storage part 49B may store and manage the virtual domain configuration of the information processing apparatus 41 in a database within the storage part 41B, for example.

The control domain 43 and each of the guest domains 45-1 through 45-N may include a periodic connection event function. The periodic connection event function may send, as the periodic connection event data, the information processing apparatus ID, the domain ID of its own domain to which the periodic connection event function belongs, a date and time or a time (hereinafter also referred to as “notification time information”) when the notification is to be made to the remote maintenance center 49 at the next periodic connection event.

On the other hand, the event receiving program 49A of the remote maintenance center 49 may include a function to receive the virtual domain configuration event from the remote maintenance program 42 of the control domain 43, and a function to receive the periodic connection event from the remote maintenance programs 42 and 44-1 through 44-N. In FIG. 3, a flow of the virtual domain configuration event is indicated by bold dotted line arrows, and a flow of the periodic connection events is indicated by bold solid line arrows. In the remote maintenance center 49, the periodic connection event received by the event receiving program 49A includes the domain ID, and thus, the domain from which the periodic connection event is received may be identified. The event receiving program 49A of the remote maintenance center 49 may store and manage the notification time information for each of the domain IDs of the same information processing apparatus ID, in the database within the storage part 49B, for example. Because the event receiving program 49A of the remote maintenance center 49 includes the function to receive the virtual domain configuration event, a periodic connection event in the virtual domain environment may be realized by storing the data of the virtual domain configuration of the information processing apparatus 41 in the storage part 49B and managing the notification time information of each of the domain IDs.

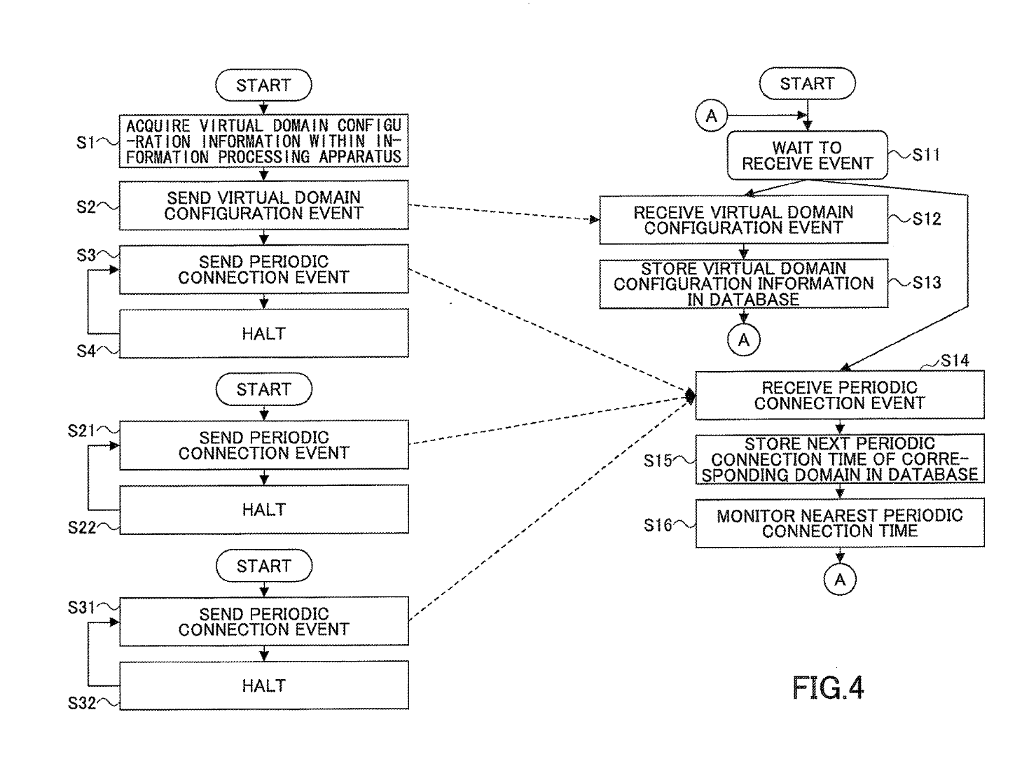

FIG. 4 is a flow chart for explaining an example of a process of the information processing apparatus 41. In FIG. 4, processes of steps S1 through S4 may be executed by the remote maintenance program 42 of the control domain 43, and processes of steps S11 through S16 may be executed by the event receiving program 49A of the remote maintenance center 49. Processes of steps S21 and S22 may be executed by the remote maintenance program 44-1 of the guest domain 45-1, and processes of steps S31 and 32 may be executed by the remote maintenance program 44-2 of the guest domain 45-2.

In FIG. 4, when the process of the information processing apparatus 41 starts, the remote maintenance program 42 acquires the virtual domain configuration information within the information processing apparatus 41, stored within the control domain 43, in step S1. In step S2, the virtual domain configuration event including the virtual domain configuration information is sent to the remote maintenance center 49 via the firmware layer 46, the interface 47-1, and the network 48. The virtual domain configuration information may include the information processing apparatus ID of the information processing apparatus 41, the number N+1 of virtual domains, domain IDs of each of the domains 43 and 45-1 through 45-N, and the like. In step S3, the periodic connection event within the control domain 43 is sent to the remote maintenance center 49. The information sent by the periodic connection event in step S3 may include the information processing apparatus ID of the information processing apparatus 41, the domain ID (that is, its own domain ID) of the control domain 43, and the time and date or the time (that is, notification time information) when the notification is to be made to the remote maintenance center 49 at the next periodic connection event. In step S4, the processing may be halted only for the time indicated by the notification time information of the periodic connection event stored within the control domain 43, and the process may thereafter return to step S3.

On the other hand, when the process of the information processing apparatus 41 starts, the remote maintenance program 44-1 sends the periodic connection event within the guest domain 45-1 to the remote maintenance center 49 via the firmware layer 46, the interface 47-1, and the network 48, in step S21. The information sent by the periodic connection event in step S21 may include the information processing apparatus ID of the information processing apparatus 41, the domain ID (that is, its own domain ID) of the guest domain 45-1, and the time and date or the time (that is, notification time information) when the notification is to be made to the remote maintenance center 49 at the next periodic connection event. In step S22, the processing may be halted only for the time indicated by the notification time information of the periodic connection event stored within the guest domain 45-1, and the process may thereafter return to step S21.

Similarly, when the process of the information processing apparatus 41 starts, the remote maintenance program 44-2 may send the periodic connection event within the guest domain 45-2 to the remote maintenance center 49 via the firmware layer 46, the interface 47-1, and the network 48, in step S31. The information sent by the periodic connection event in step S31 may include the information processing apparatus ID of the information processing apparatus 41, the domain ID (that is, its own domain ID) of the guest domain 45-2, and the time and date or the time (that is, notification time information) when the notification is to be made to the remote maintenance center 49 at the next periodic connection event. In step S32, the processing may be halted only for the time indicated by the notification time information of the periodic connection event stored within the guest domain 45-2, and the process may thereafter return to step S31. The process of the remote maintenance program 44-i (in this example, i=3, . . . , N) may be the same as that of steps S31 and S32 (or steps S21 and S22), and thus, illustration and description thereof will be omitted.

When the process of the remote maintenance center 49 starts, step S11 may wait for reception of the event via the network 48. The process may advance to step S12 when the received event is the virtual domain configuration event, and the process may advance to step S14 when the received event is the periodic connection event. The virtual domain configuration event from the control domain 43 is received in step S12. The virtual domain configuration event received in step S12 may include the virtual domain configuration information. The virtual domain configuration information may include the information processing apparatus ID of the information processing apparatus 41, the number N+1 (of virtual domains (or a number N of the guest domains 45-1 through 45-N), and data such as the domain IDs for identifying each of the domains 43 and 45-1 through 45-N, and the like. In step S13, a data storage region corresponding to the number of virtual domains included in the virtual domain configuration information of the received virtual domain configuration event may be secured within the storage part 49B, and the received virtual domain configuration information may be stored in the database within the storage part 48B, in order to update the virtual domain configuration information, and the process may return to step S11.

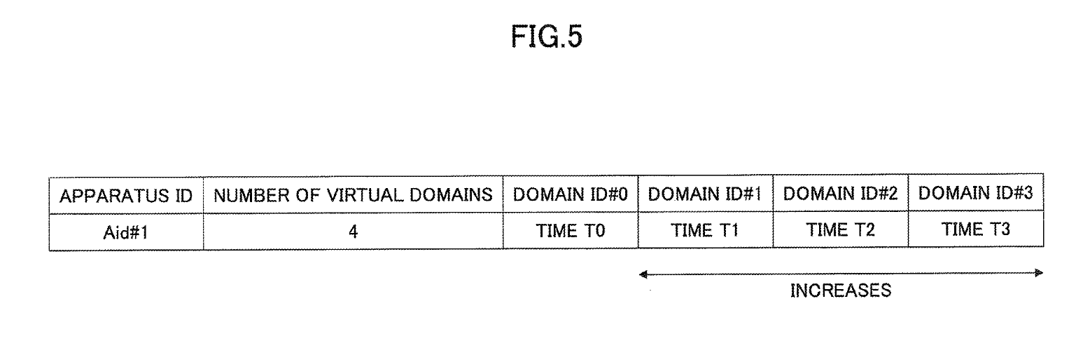

On the other hand, in step S14, the event receiving program 49A may receive the periodic connection event from one of the control domains 43 and the guest domains 45-1 and 45-2. The received periodic connection event may include the information processing apparatus ID of the information processing apparatus 41, the domain ID indicating the domain that sent the periodic connection event, and the time and date or the time (that is, notification time information) when the notification is to be made to the remote maintenance center 49 from the domain that sent the periodic connection event (that is, the domain having the above domain ID) at the next periodic connection event. Accordingly, the remote maintenance center 49 may know the time when the next periodic connection event will be sent from each virtual domain. In step S15, the notification time information illustrated in FIG. 5 and included in the periodic connection event may be stored in the database within the storage part 49B. FIG. 5 is a diagram for explaining an example of the notification time information stored in the storage part 49B of the remote maintenance center 49. In the example of the data stored in the database illustrated in FIG. 5, with respect to the information processing apparatus ID Aid#1 of the information processing apparatus 41, the number N+1 of virtual domains is 4, and the notification time information of the domains 43, 44-1, 44-2, and 44-N (in this example, N=3) having the domain ID#0 through #3 is T0, T1, T2, and T3, respectively. In step S16, the event receiving program 49A may monitor the notification time information, stored in the database illustrated in FIG. 5, and indicating the next periodic connection time (that is, the nearest periodic connection time), and the process may return to step S11.

Accordingly, even in the virtual domain environment, the notification of the periodic connection event from each virtual domain to the remote maintenance center, that is, the abnormality notification, may be performed positively. As a result, a remote maintenance may be realized in which no manual confirmation is required to confirm whether an abnormality is generated in the information processing apparatus.

Of course, a plurality of information processing apparatuses having the same structure as the information processing apparatus 41 may be connected to the remote maintenance center 49 via the network 48. Each information processing apparatus may have an information processing apparatus ID uniquely assigned thereto, and thus, the remote maintenance center 49 may identify each information processing apparatus based on the information processing apparatus ID thereof.

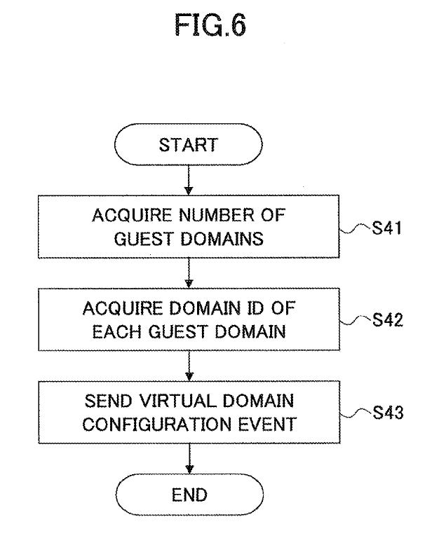

Next, a description will be given of a process to send the virtual domain configuration event in step S2 illustrated in FIG. 4, by referring to FIG. 6. FIG. 6 is a flow chart for explaining an example of the process to send the virtual domain configuration event. The send process illustrated in FIG. 6 may be started when a virtual domain is newly formed, or when a guest domain is increased, or when the guest domain is decreased. In step S41, the remote maintenance program 42 of the control domain 43 may acquire the number N+1 of virtual domains (or the number N of guest domains 45-1 through 45-N) stored within the control domain 43. In step S42, the remote maintenance program 42 may acquire the domain IDs for identifying each of the domains 43 and 45-1 through 45-N, stored within the control domain 43. In step S43, the remote maintenance program 42 may acquire the information processing apparatus ID for identifying the information processing apparatus 41, stored within the control domain 43, and send the virtual domain configuration event including the virtual domain configuration information to the remote maintenance center 49. The virtual domain configuration information may include the information processing apparatus ID, the number N+1 of virtual domains (or the number N of guest domains 45-1 through 45-N), the domain IDs for identifying each of the domains 43 and 45-1 through 45-N, and the like. Hence, the remote maintenance center 49 may receive the virtual domain configuration information indicating the virtual domains presently formed within the information processing apparatus 41.

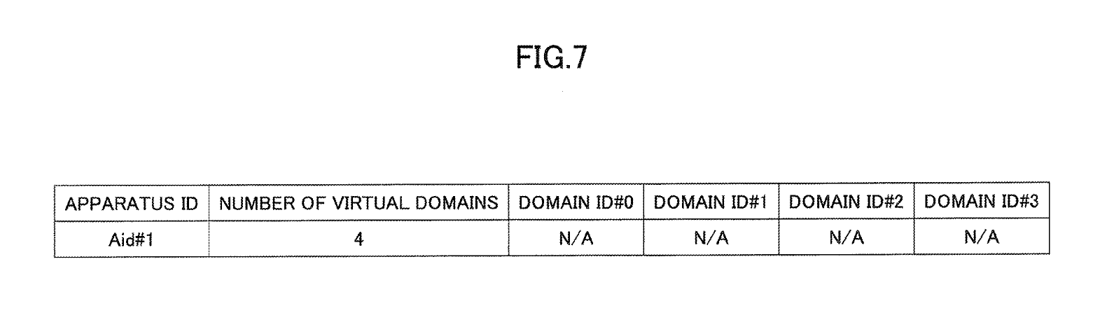

FIG. 7 is a diagram for explaining an example of data notified by the send process to send the virtual domain configuration event. In the example of the data stored in the database illustrated in FIG. 7, with respect to the information processing apparatus ID Aid#1 of the information processing apparatus 41, the number N+1 of virtual domains is 4, and the domain IDs of the domains 43, 44-1, 44-2, and 44-N (in this example, N=3) are ID#0 through #3, respectively.

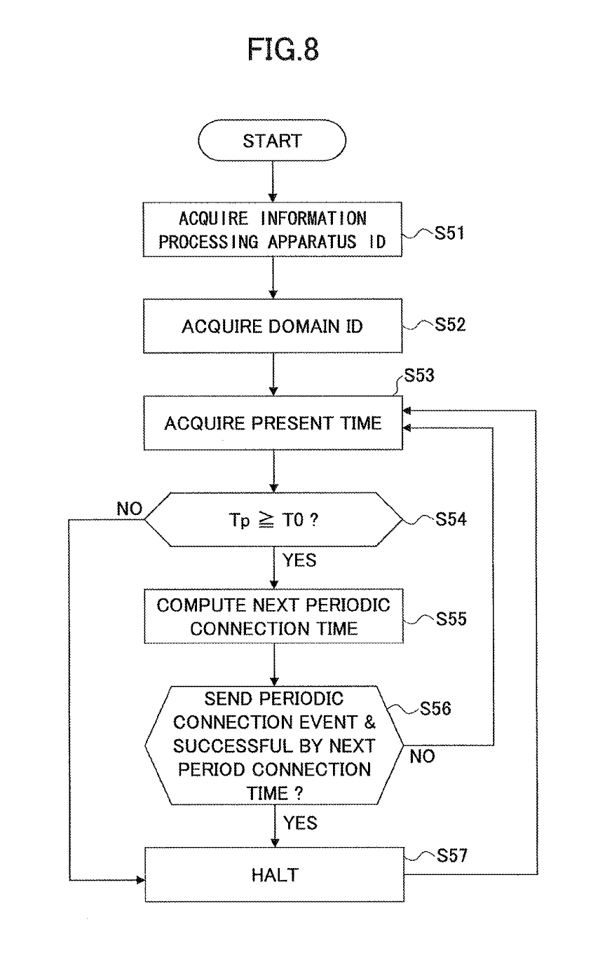

Next, a description will be given of a process to send the periodic connection event in steps S3 and S4 illustrated in FIG. 4, by referring to FIG. 8. FIG. 8 is a flow chart for explaining an example of the process to send the periodic connection event. The send process illustrated in FIG. 8 may be started after the virtual domain configuration information is formed (that is, together with the start of the remote maintenance service). Steps S51 through S56 may correspond to step S3 illustrated in FIG. 4, and step S57 may correspond to step S4 illustrated in FIG. 4.

In step S51 illustrated in FIG. 8, the remote maintenance program 42 may acquire the information processing apparatus ID for identifying the information processing apparatus 41, stored within the control domain 43. In step S52, the remote maintenance program 42 may acquire the domain ID of the control domain 43 stored within the control domain 43. In step S53, the remote maintenance program 42 may acquire present time Tp from an internal clock of the information processing apparatus 41. In step S54, the remote maintenance program 42 may compare the present time Tp and the notification time information (in this example, periodic connection tie T0) of the periodic connection event stored within the control domain 43, and judge whether the periodic connection time T0 is less than or equal to the present time Tp. When the judgement result in step S54 is YES, the remote maintenance program 42 may compute the next periodic connection time from the notification time information stored within the control domain 43, in step S55. In step S56, the remote maintenance program 42 may send the periodic connection event to the remote maintenance center 49, and judge whether the sending of the periodic connection event succeeds by the next periodic connection time. When the judgement result in step 56 is NO, the process may return to step S53. On the other hand, when the judgement result in step S54 is NO, or when the judgement result in step S56 is YES, the process may advance to step S57. In step S57, the remote maintenance program 42 may halt the process only for the time indicated by the notification time information of the periodic connection event stored within the control domain 43, and the process may thereafter return to step S53.

The process to send the periodic connection event in each guest domain 45-i (i=1, . . . , N) may be performed basically in a manner similar to the process to send the periodic connection event in the control domain 43 illustrated in FIG. 8. However, the domain ID acquired in step corresponding to step S52, and the periodic connection time Tj (j=i+1) used in step corresponding to step S54 may be respectively acquired from the corresponding guest domain 45-i.

The time and intervals at which the periodic connection event is to be notified, included in the notification time information stored in each virtual domain, may be freely determined by a manager of each virtual domain, for example. For example, the manager of each virtual domain may set the time to notify the periodic connection event to late night, holiday, and the like when the frequency of use of the domain is relatively low.

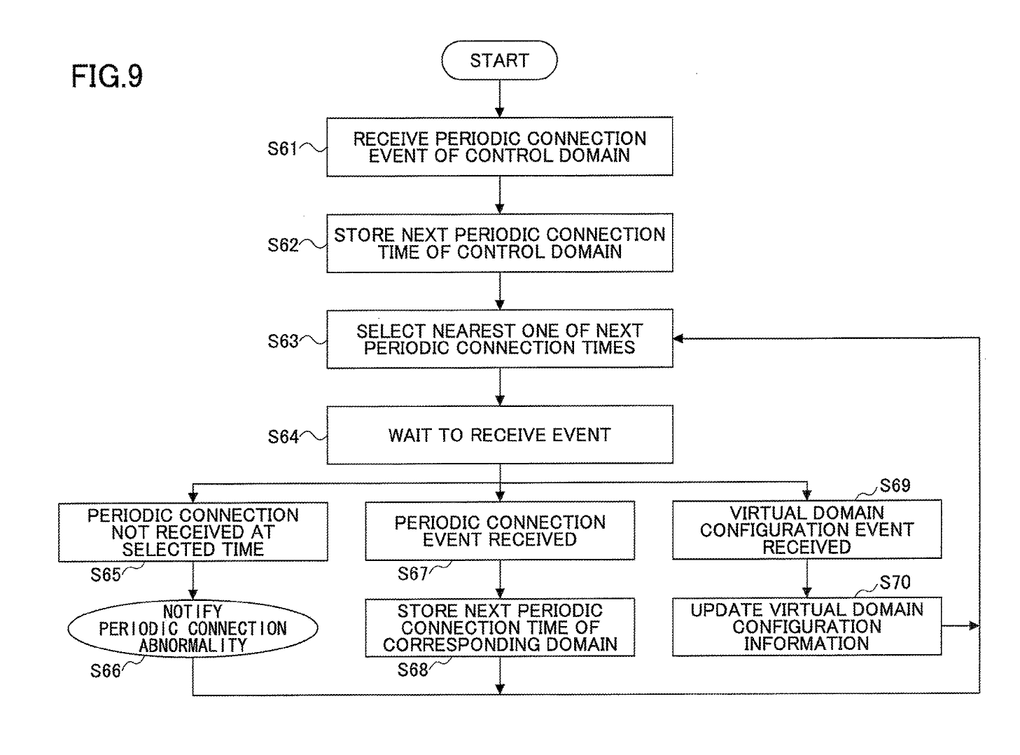

FIG. 9 is a flow chart for explaining an example of a process of the event receiving program 49A. The process illustrated in FIG. 9 may be started when the event received from the information processing apparatus 41 is the periodic connection event received after the virtual domain configuration event received from the control domain 43. Steps 61 through S63 and S64 may correspond to steps S14 through S16 and S11 illustrated in FIG. 4, respectively. Steps S67 and S68 may correspond to steps S14 and S15 illustrated in FIG. 4 with respect to the next received periodic connection event. Steps S69 and S70 may correspond to steps S12 and S13 illustrated in FIG. 4, respectively.

In step S61 illustrated in FIG. 9, the event receiving program 49A may receive the periodic connection event from one of the control domain 43 and the guest domains 45-1 and 45-2. The periodic connection event may include the information processing apparatus ID of the information processing apparatus 41 which is the source of the periodic connection event, the domain ID indicating the source virtual domain from which the periodic connection event is sent, and the notification time information (next periodic connection time) to be notified to the remote maintenance center 49 at the next periodic connection event from the virtual domain having the above domain ID indicating the source virtual domain. In step S62, the event receiving program 49A may store the next periodic connection time included in the received periodic connection event into the database within the storage part 49B. In step S63, the event receiving program 49A may select and monitor the next periodic connection time that is nearest amongst the next periodic connection times stored in the database.

In step S64, the event receiving program 49A may wait for reception of the event via the network 48. When the event receiving program 49A in step S65 confirms that no periodic connection event is received from the virtual domain corresponding to the next periodic connection time selected in step S63, a notification indicating a periodic connection abnormality may be made in step S66 to notify the manager of the information processing apparatus 41, or the manager of the control domain 43, or the manager of the corresponding virtual domain. The process may return to step S63 after step S66.

When the event receiving program 49A in step S67 confirms that the periodic connection event is received from the virtual domain corresponding to the next periodic connection time selected in step S63, the next periodic connection time included in the received periodic connection event may be stored in the database within the storage part 49B in step S68, and the process may return to step S63.

When the event receiving program 49A in step S69 confirms that the virtual domain configuration event is received from the control domain 43, a data storage region amounting to the number of virtual domains included in the virtual domain configuration information of the received virtual domain configuration event may be secured within the storage part 49B, and the virtual domain configuration information may be stored in the database within the storage part 49B in order to update the virtual domain configuration information, in step S70. The process may return to step S63 after step S70.

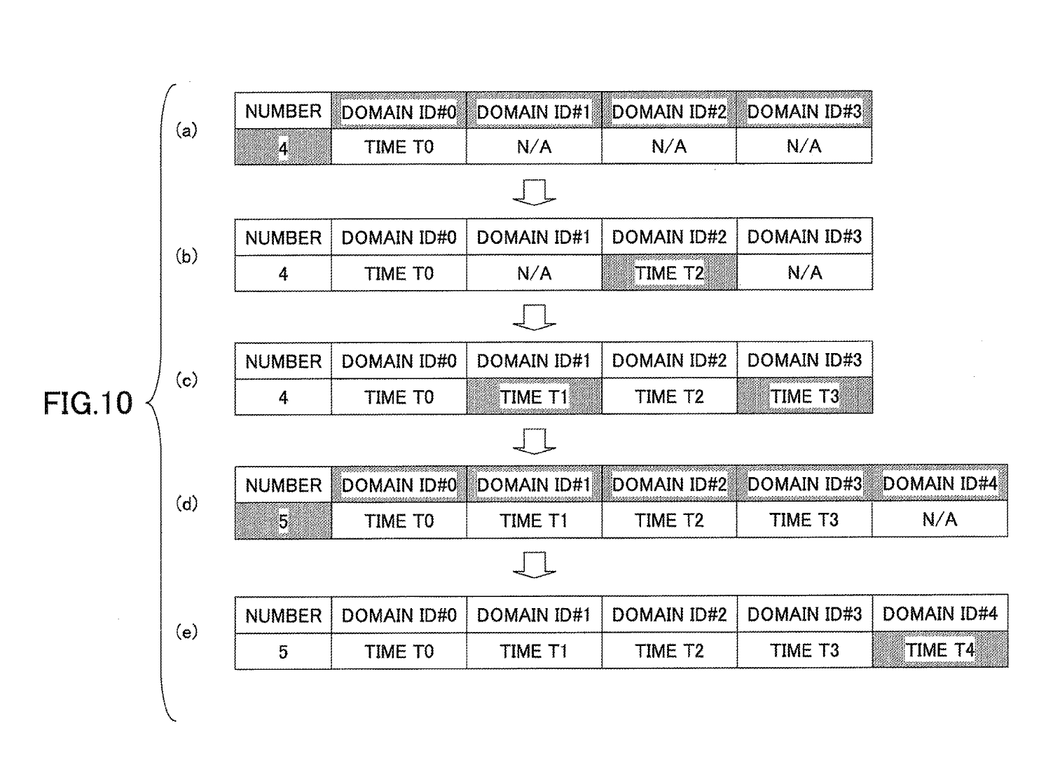

FIG. 10 is a diagram for explaining an example of a transition for a case in which the data of guest domains stored in the remote maintenance center 49 increases. In FIG. 10, (a) indicates an initial state of the data stored in the database within the storage part 49B with respect to the information processing apparatus ID of the information processing apparatus 41, and only the next notification time information (or time) T0 of the control domain 43, amongst the domains 43, 44-1, 44-2, and 44-N (in this example, N=3) having the domain IDs ID#0 through ID#3, is stored because the virtual domain configuration event is received from the control domain 43. In FIG. 10, the illustration of the information processing apparatus ID is omitted, and “number” indicates the number of virtual domains.

In FIG. 10, (b) indicates a state in which next notification time information T2 of the guest domain 45-2 is stored in the database as indicated by hatchings, because the periodic connection event is received from the guest domain 45-2. In FIG. 10, (c) indicates a state in which next notification time information T1 and T3 of the guest domains 45-1 and 45-3 is stored in the database as indicated by hatchings, because the periodic connection events are received from the guest domains 45-1 and 45-3.

In FIG. 10, (d) indicates a state in which the data storage region of the storage part 49B is extended and a virtual domain 45-4 having a newly formed domain ID ID#4 is additionally stored in the database as indicated by hatchings, because the virtual domain configuration event due to the increase in the virtual domains is received from the control domain 43. In FIG. 10, (e) indicates a state in which next notification time information T4 of the guest domain 45-4 is stored in the database as indicated by hatchings, because the periodic connection event is received from the guest domain 45-4.

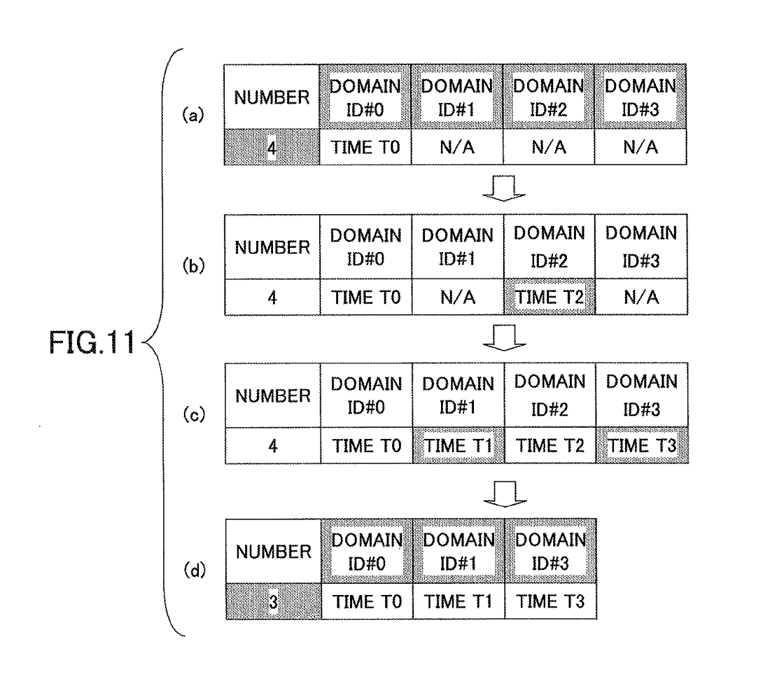

FIG. 11 is a diagram for explaining an example of a transition for a case in which the data of guest domains stored in the remote maintenance center 49 decreases. In FIG. 11, (a) indicates an initial state of the data stored in the database within the storage part 49B with respect to the information processing apparatus ID of the information processing apparatus 41, and only the next notification time information (or time) T0 of the control domain 43, amongst the domains 43, 44-1, 44-2, and 44-N (in this example, N=3) having the domain IDs ID#0 through ID#3, is stored because the virtual domain configuration event is received from the control domain 43. In FIG. 11, the illustration of the information processing apparatus ID is omitted, and “number” indicates the number of virtual domains.

In FIG. 11, (b) indicates a state in which next notification time information T2 of the guest domain 45-2 is stored in the database as indicated by hatchings, because the periodic connection event is received from the guest domain 45-2. In FIG. 11, (c) indicates a state in which next notification time information T1 and T3 of the guest domains 45-1 and 45-3 is stored in the database as indicated by hatchings, because the periodic connection events are received from the guest domains 45-1 and 45-3.

In FIG. 11, (d) indicates a state in which the data storage region of the storage part 49B is reduced and the virtual domain 45-2 having the domain ID ID#2 is deleted from the database, because the virtual domain configuration event due to the decrease in the virtual domains is received from the control domain 43.

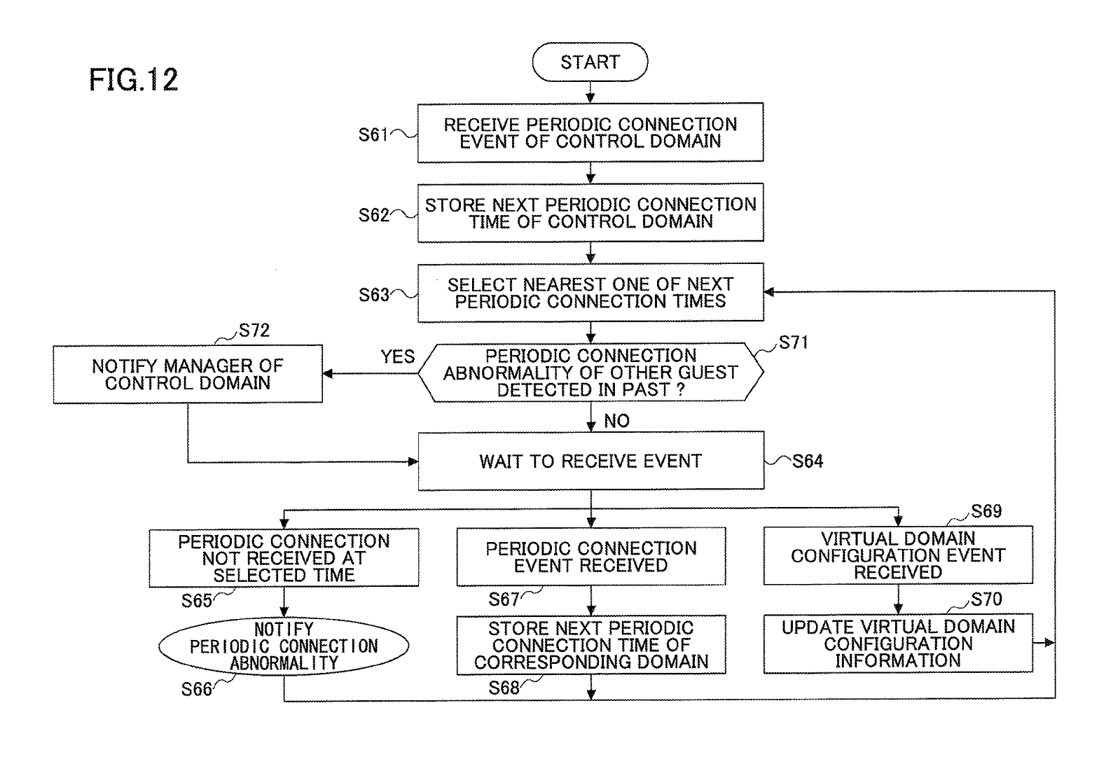

FIG. 12 is a flow chart for explaining another example of the process of the event receiving program 49A. In FIG. 12, those steps that are the same as those corresponding steps in FIG. 9 are designated by like reference numerals, and a description thereof will be omitted.

In FIG. 12, step S71 is executed after step S63. In step S71, the event receiving program 49A may judge whether a periodic connection abnormality is detected with respect to a virtual domain other than the source of the periodic connection event received in the past in step S61. When the judgement result in step S71 is YES, the event receiving program 49A may notify the periodic connection abnormality detected in the past to the manager of the information processing apparatus 41, or the manager the control domain 43, in step S72, and the process may advance to step S64. On the other hand, when the judgement result in step S71 is NO, the process may advance to step S64.

In a modification, in place of step S71, a judgement may be made to determine whether the periodic connection abnormalities of each virtual domain that are accumulated amounts to a predetermined number or greater. When the result of this judgement is YES, the periodic connection abnormality may be notified to the manager of the control domain 43. Alternatively a judgment may be made to determine whether the periodic connection abnormalities are detected from a number of virtual domain amounting to a predetermined number of greater, and when the result of this judgment is YES, the periodic connection abnormality may be notified to the manager of the control domain 43. The manager of the control domain 43, in many cases, may manage the entire information processing apparatus 41. Hence, this modification may be effective in a case in which the cause of the periodic connection abnormality exists in the entire information processing apparatus 41 and not in one of the guest domains 45-1 through 45-N.

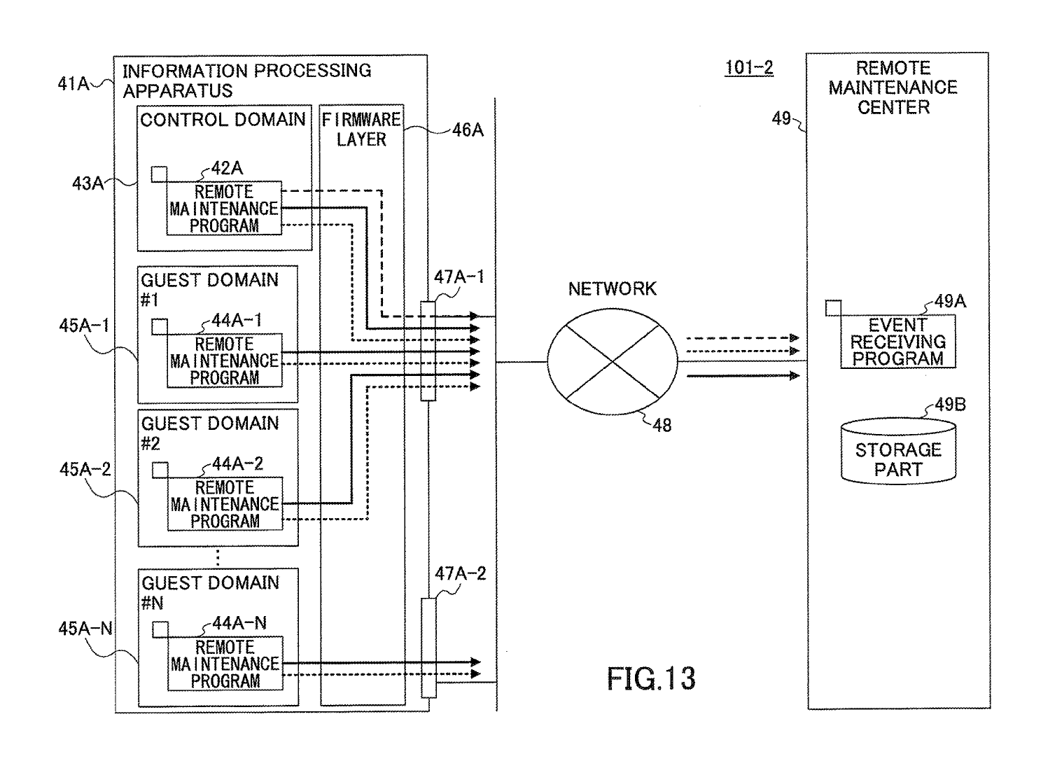

FIG. 13 is a diagram illustrating an example of the network system in a second embodiment. In FIG. 13, those parts that are the same as those corresponding parts in FIG. 3 are designated by like reference numerals, and a description thereof will be omitted. In FIG. 13, a network system 101-2 may include an information processing apparatus 41A, a network 48 formed by the Internet or dedicated line, and a remote maintenance center 49. The information processing apparatus 41A may include a control domain 43A that includes a remote maintenance program 42A, guest domains 45A-1 through 45A-N including remote maintenance programs 44A-1 through 44A-N, respectively, a firmware layer 46A, and interfaces 47A-1 and 47A-2.

Each of the remote maintenance programs 42A and 44A-1 through 44A-N may additionally include a known function to send a start or stop event to indicate that its own domain is started or stopped. In FIG. 13, the flow of the start or stop event is indicated by thin dotted line arrows. In this embodiment, because each of the domains 43A and 45A-1 through 45A-N may send the start or stop event to indicate that its own domain is started or stopped, the remote maintenance center 49 may confirm that no periodic connection abnormality is generated in a certain virtual domain when the stop event is received from this certain virtual domain, even when no periodic connection event is received from this certain virtual domain. In other words, the remote maintenance center 49 may judge or discriminate whether the virtual domain is in the stopped state or the periodic connection abnormality is generated in the virtual domain.

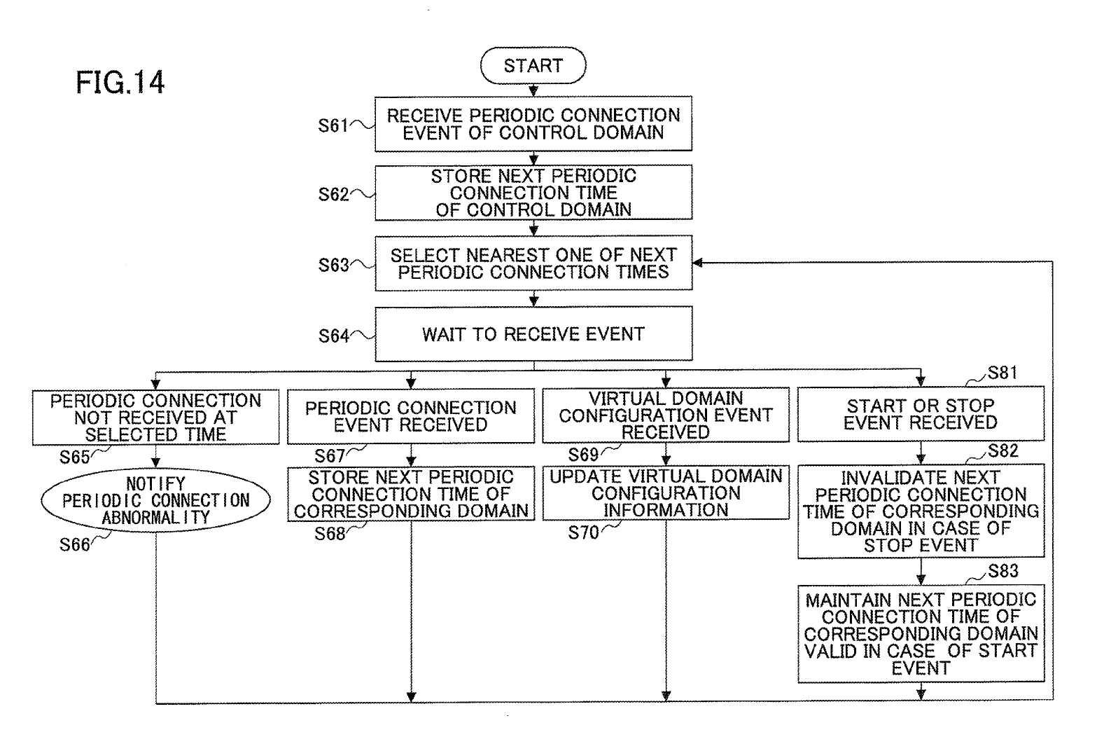

FIG. 14 is a flow chart for explaining an example of a process of the event receiving program 49A corresponding to the start or stop event. In FIG. 14, those steps that are the same as those corresponding steps in FIG. 9 are designated by like reference numerals, and a designated by the same reference numerals, and a description thereof will be omitted.

In step S81 illustrated in FIG. 14, the event receiving program 49A may receive the start or stop event from the virtual domain. In step S82, when the event received from the virtual domain is the stop event, the event receiving program 49A may invalidate the next periodic connection time of this virtual domain until the start event is received from this virtual domain. In step S83, when the event received from the virtual domain is the start event, the event receiving program 49A may maintain validity of the next periodic connection time of this virtual domain until the stop event is received from this virtual domain. The process may return to step S63 after step S83.

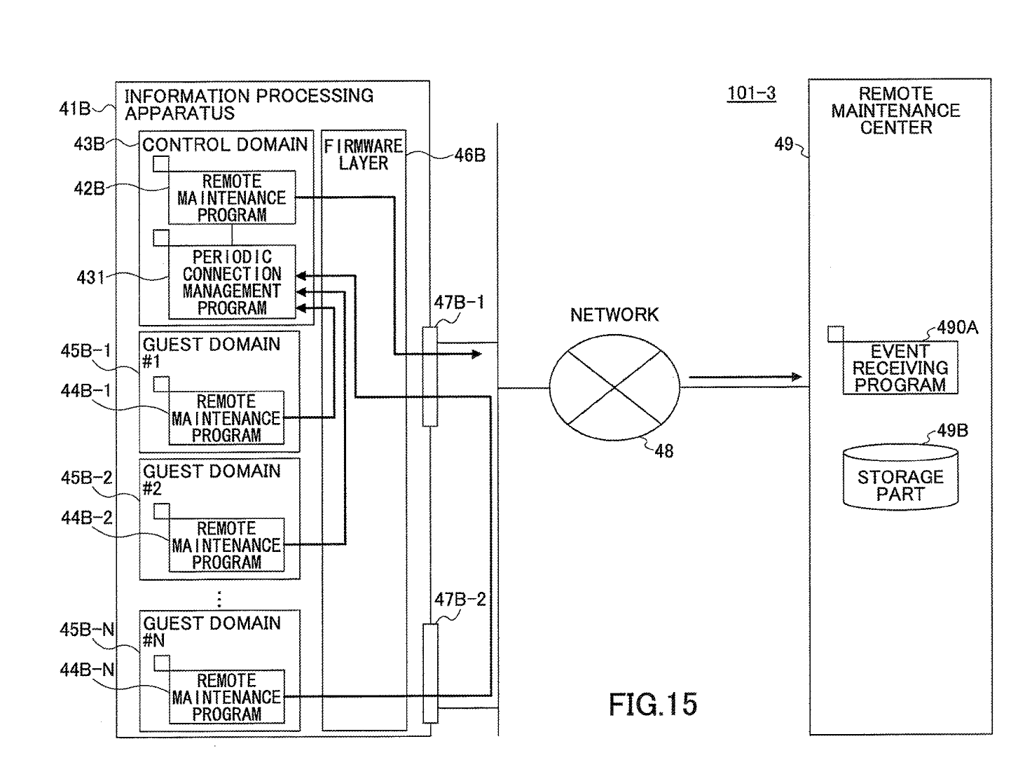

FIG. 15 is a diagram illustrating an example of the network system in a third embodiment. In FIG. 15, those parts that are the same as those corresponding parts in FIG. 3 are designated by like reference numerals, and a description thereof will be omitted. In FIG. 15, a network system 101-3 may include an information processing apparatus 41B, a network 48 formed by the Internet or dedicated line, and a remote maintenance center 49. The remote maintenance center 49 may include an event receiving program 490A and a storage part 49B. The event receiving program 490A may include functions excluding the function of each of the above described embodiments to receive the periodic connection event from the event receiving program 49A. The information processing apparatus 41B may include a control domain 43B that includes a remote maintenance program 42B and a periodic connection management program 431, guest domains 45B-1 through 45B-N including remote maintenance programs 44B-1 through 44B-N, respectively, a firmware layer 46B, and interfaces 47B-1 and 47B-2.

In FIG. 15, the periodic connection events from the remote maintenance programs 44B-1 through 44B-N of the guest domains 45B-1 through 45B-N may be notified to the periodic connection management program 431 of the control domain 43. In this example, the periodic connection events from the remote maintenance programs 44B-1 and 44B-2 may be notified to the periodic connection management program 431 via the firmware layer 46B, and the periodic connection event from the remote maintenance program 44B-N (N=3) may be notified to the periodic connection management program 431 via the interface 47B-2 and the firmware layer 46B. By physically passing the periodic connection event from the guest domain 45B-NB (N=3) that is allocated with the dedicated interface 47B-2 through this interface 47B-2 before notifying the periodic connection event to the control domain 43B, a normal operation of the interface 47B-2, free of abnormalities, may be confirmed.

The remote maintenance program 42B of the control domain 43B may send the virtual domain configuration event and the periodic connection event from the control domain 43B and the periodic connection event from the guest domains 45B-1 through 45B-N to the remote maintenance center 49. The remote monitoring programs 44B-1 through 44B-N of each of the guest domains 45B-1 through 45B-N may basically perform an operation similar to that of FIG. 6, except that a sending destination of the periodic connection event is changed from the remote maintenance center 49 to the control domain 43B (more particularly, the periodic connection management program 431) within the information processing apparatus 41B.

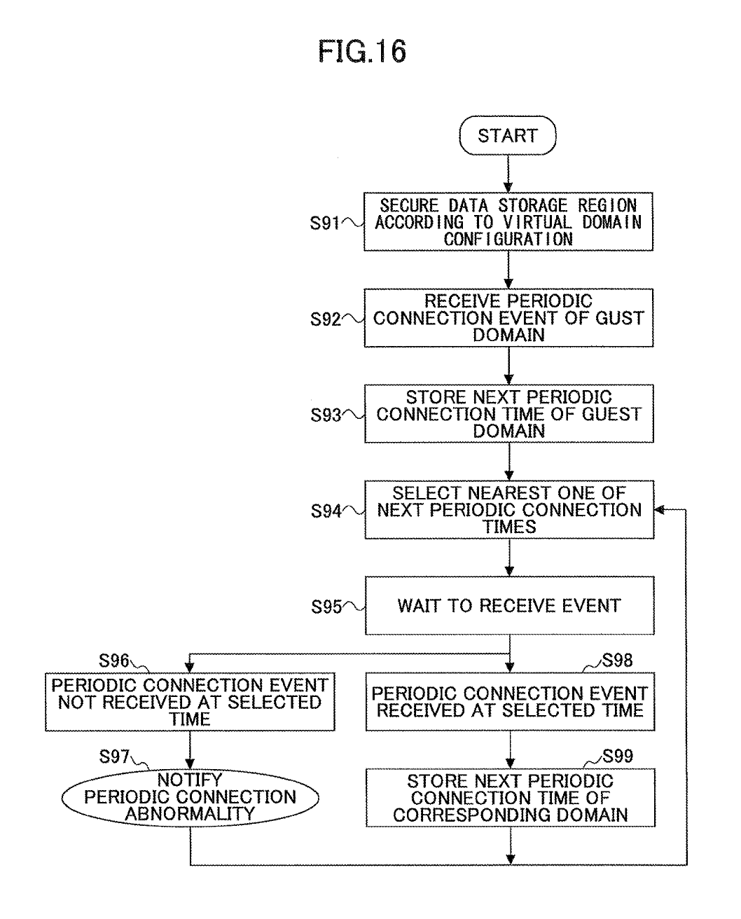

FIG. 16 is a flow chart for explaining an example of a process of a periodic connection management program 431. The periodic connection management program 431 may include functions of the event receiving program 49A of the first embodiment by excluding the function to receive the virtual domain configuration event. That is, the periodic connection management program 431 may include the function of the event receiving program 49A to receive the periodic connection event.

In step S91 illustrated in FIG. 16, the periodic connection management program 431 may secure a data storage region to accept the periodic connection events from the guest domains 45B-1 through 45B-N within the control domain 43 according to the virtual domain configuration information. In step S92, the periodic connection management program 431 may receive the periodic connection event from one of the guest domains 45B-1 through 45B-N. The periodic connection event may include the information processing apparatus ID of the information processing apparatus 41 which is the source of the periodic connection event, the domain ID indicating the source virtual domain from which the periodic connection event is sent, and the notification time information (next periodic connection time) to be notified to the remote maintenance center 49 at the next periodic connection event from the virtual domain having the above domain ID indicating the source virtual domain. In step S93, the periodic connection management program 431 may store the next periodic connection time included in the received periodic connection event into the control domain 43B (more particularly, the storage part of the information processing apparatus 41). The information related to the periodic connection events of the guest domains 45B-1 through 45B-N stored within the control domain 43B may be stored in a database. In step S94, the periodic connection management program 431 may select and monitor the next periodic connection time that is nearest amongst the next periodic connection times stored within the control domain 43B.

In step S95, the periodic connection management program 431 may wait for reception of the event from the guest domains 45B-1 through 45B-N. In step S96, when the periodic connection management program 431 confirms that no periodic connection event is received from the guest domain corresponding to the next periodic connection time selected in step S94, the periodic connection management program 431 may notify the periodic connection abnormality in step S97. The periodic connection abnormality may be notified to the manager of the information processing apparatus 41B, or the manager of the control domain 43B, or the manager of the corresponding one of the guest domains 45B-1 through 45B-N. The process may return to step S94 after step S97.

In step S98, when the periodic connection management program 431 confirms receipt of the periodic connection event from the guest domain corresponding to the next periodic connection time selected in step S94, the periodic connection management program 431 may store the next periodic connection time included in the received periodic connection event into the control domain 43B in step S99. The process may return to step S94 after step S99

According to this embodiment, the scale of the event receiving program 490 of the remote maintenance center 49 may be reduced, and a load on the remote maintenance center 49 may be reduced.

This embodiment may also include the function to notify the start or stop event of the virtual domain, as is the case of the second embodiment described above. In this case, each guest domain may sent the start or stop event to the control domain, in a manner similar to the periodic connection event, while the control domain may send the start or stop event to the remote maintenance center, in a manner similar to the periodic connection event of the control domain and each of the guest domains.

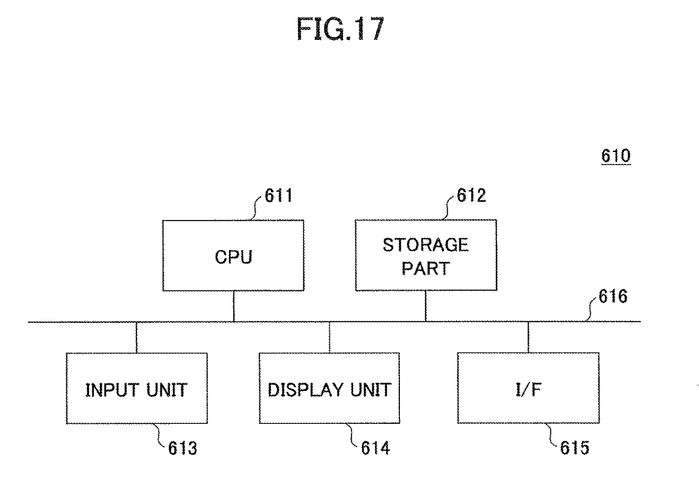

In each of the embodiments described above, the information processing apparatus may be formed by a computer system illustrated in FIG. 17, for example. FIG. 17 is a block diagram illustrating an example of the computer system forming the information processing apparatus.

A computer system 610 illustrated in FIG. 17 may include a CPU (Central Processing Unit) 611, a storage part (or storage unit) 612, an input unit (or input device) 613, a display unit 614, and an interface (I/F) 615 that may be connected via a bus 616. The CPU 611 may execute one or more programs stored in the storage part 612, in order to control the entire computer system 610. The storage part 612 may be formed by a semiconductor memory device, a magnetic recording medium, an optical recording medium, a magneto-optical recording medium, and the like. The storage part 612 may store one or more programs and various data. The storage part 612 that stores the program may form an example of a non-transitory computer-readable storage medium. The storage part 612 may store intermediate results and computation results of computations executed by the CPU 611 and the like, and may also be used as a temporary (or secondary) memory. The storage part 612 may be formed by a plurality of storage units. In addition, the program may be installed into the storage part 612 from an external apparatus (not illustrated) that is connected to the computer system 610 via a network (not illustrated). When the computer system 610 communicates with the external apparatus via the network or the like, the communication may be performed via the interface 615 that is connected to the network and the bus 616. The input unit 613 may be formed by a keyboard or the like. The display unit 614 may display various information including messages urging the operator to input instructions or data, various abnormality notifications, and the like. The input unit 613 and the display unit 614 may be formed by an input and output unit having the functions of both the input unit and the display unit, such as a touch-screen panel.

In a case in which the computer system 610 forms the information processing apparatus 41 illustrated in FIG. 3, for example, the storage part 612 may store the remote maintenance programs 42 and 44-1 through 44-N, the information processing apparatus ID, the number N+1 of virtual domains (or the number N of guest domains), the domain ID of each virtual domain respectively forming the virtual domain configuration information, and the like. In a case in which the computer system 610 forms the information processing apparatus 41B illustrated in FIG. 15, for example, the storage part 612 may further store the periodic connection management program 431, the information related to the periodic connection events from the guest domains 44B-1 through 44B-N, and the like.

On the other hand, in a case in which the computer system 610 forms the remote maintenance center 49 illustrated in FIG. 3, for example, the storage part 612 may store the event receiving program 49A, various databases to store information related to the events from the virtual domains of each information processing apparatus, and the like. In this case, the storage part 612 may form the storage part 49B.

Although the embodiments are numbered with, for example, “first,” “second,” or “third,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a first sending unit configured to send, to a remote maintenance center, virtual domain configuration information indicating configurations of a plurality of virtual domains formed within the information processing apparatus, together with a virtual domain configuration event; and
a second sending unit configured to send, to the remote maintenance center, information of a periodic connection event including a next periodic connection time of each of the plurality of virtual domains, together with a periodic connection event.

2. The information processing apparatus as claimed in claim 1, wherein
the virtual domain configuration information include an information processing apparatus ID for identifying the information processing apparatus, a number of the plurality of virtual domains, and a domain ID for identifying each of the plurality of virtual domains, and
the information of the periodic connection event includes the information processing apparatus ID, the domain ID of a certain virtual domain sending the periodic connection event, and a date and time or time when the certain virtual domain is to send a next periodic connection event.

3. The information processing apparatus as claimed in claim 1, wherein
the plurality of virtual domains include a control domain configured to manage all virtual domains within the information processing apparatus, and a plurality of guest domains other than the control domain,
the control domain includes the first sending unit, and
the control domain and each of the plurality of guest domains include the second sending unit.

4. The information processing apparatus as claimed in claim 1, wherein
the plurality of virtual domains include a control domain configured to manage all virtual domains within the information processing apparatus, and a plurality of guest domains other than the control domain,
the control domain includes the first sending unit,
each of the plurality of guest domains includes the second sending unit to send the periodic connection event from each of the plurality of guest domains to the control domain, and
the control domain includes the second sending unit to send the periodic connection event of the control domain and the periodic connection event of each of the plurality of guest domains to the remote maintenance center.

5. The information processing apparatus as claimed in claim 1, further comprising:
a third sending unit configured to send a start or stop event of each of the virtual domains to the remote maintenance center.

6. A remote maintenance method to send information from an information processing apparatus to a remote maintenance center,
wherein the information processing apparatus performs a process comprising:
first sending to the remote maintenance center, virtual domain configuration information indicating configurations of a plurality of virtual domains formed within the information processing apparatus, together with a virtual domain configuration event; and
second sending to the remote maintenance center, information of a periodic connection event including a next periodic connection time of each of the plurality of virtual domains, together with a periodic connection event, and
wherein the remote maintenance center performs a process comprising:
managing the periodic connection event from each of the plurality of virtual domains based on the virtual domain configuration information and detecting a periodic connection abnormality.

7. The remote maintenance method as claimed in claim 6, wherein
the virtual domain configuration information include an information processing apparatus ID for identifying the information processing apparatus, a number of the plurality of virtual domains, and a domain ID for identifying each of the plurality of virtual domains, and
the information of the periodic connection event includes the information processing apparatus ID, the domain ID of a certain virtual domain sending the periodic connection event, and a date and time or time when the certain virtual domain is to send a next periodic connection event.

8. The remote maintenance method as claimed in claim 6, wherein
the plurality of virtual domains include a control domain configured to manage all virtual domains within the information processing apparatus, and a plurality of guest domains other than the control domain,
the control domain executes the first sending, and
the control domain and each of the plurality of guest domains execute the second sending.

9. The remote maintenance method as claimed in claim 6, wherein
the plurality of virtual domains include a control domain configured to manage all virtual domains within the information processing apparatus, and a plurality of guest domains other than the control domain,
the control domain executes the first sending,
each of the plurality of guest domains executes the second sending to send the periodic connection event from each of the plurality of guest domains to the control domain, and
the control domain executes the second sending to send the periodic connection event of the control domain and the periodic connection event of each of the plurality of guest domains to the remote maintenance center.

10. The remote maintenance method as claimed in claim 6, further comprising:
a third sending a start or stop event of each of the virtual domains to the remote maintenance center.

11. A non-transitory computer-readable storage medium having stored therein a program for causing a computer to execute a process comprising:
first sending, to a remote maintenance center, virtual domain configuration information indicating configurations of a plurality of virtual domains formed within the information processing apparatus, together with a virtual domain configuration event; and
second sending, to the remote maintenance center, information of a periodic connection event including a next periodic connection time of each of the plurality of virtual domains, together with a periodic connection event.

12. The non-transitory computer-readable storage medium as claimed in claim 11, wherein
the virtual domain configuration information include an information processing apparatus ID for identifying the information processing apparatus, a number of the plurality of virtual domains, and a domain ID for identifying each of the plurality of virtual domains, and
the information of the periodic connection event includes the information processing apparatus ID, the domain ID of a certain virtual domain sending the periodic connection event, and a date and time or time when the certain virtual domain is to send a next periodic connection event.

13. The non-transitory computer-readable storage medium as claimed in claim 11, wherein
the plurality of virtual domains include a control domain configured to manage all virtual domains within the information processing apparatus, and a plurality of guest domains other than the control domain,
the control domain executes the first sending, and
the control domain and each of the plurality of guest domains execute the second sending.

14. The non-transitory computer-readable storage medium as claimed in claim 11, wherein
the plurality of virtual domains include a control domain configured to manage all virtual domains within the information processing apparatus,
and a plurality of guest domains other than the control domain,
the control domain executes the first sending,
each of the plurality of guest domains executes the second sending to send the periodic connection event from each of the plurality of guest domains to the control domain, and
the control domain includes the second sending to send the periodic connection event of the control domain and the periodic connection event of each of the plurality of guest domains to the remote maintenance center.

15. The non-transitory computer-readable storage medium as claimed in claim 11, wherein the process further comprises:
third sending a start or stop event of each of the virtual domains to the remote maintenance center.
